(19) United States
(12) Patent Application Publication
(10) Pub. No.: US 2026/0008402 A1
(43) Pub. Date: Jan. 8, 2026

(54) PINLESS REEL TRAILER LOCKING MECHANISM

(71) Applicant: REELSTRONG LLC, Manheim, PA (US)

(72) Inventor: Brandon CHRIST, Millersville, PA (US)

(21) Appl. No.: 19/261,463

(22) Filed: Jul. 7, 2025

Related U.S. Application Data
(60) Provisional application No. 63/667,967, filed on Jul. 5, 2024.
(60) Provisional application No. 63/815,032, filed on May 30, 2025.

(51) Int. Cl. B60P 3/035; B60P 7/135; B62D 21/20

(52) U.S. Cl. CPC B60P 3/035; B60P 7/135; B62D 21/20

(57) ABSTRACT

In an exemplary embodiment, a pinless reel trailer is provided. The pinless reel trailer includes a pair of frames, each frame for supporting a corresponding portion of a rack of a rack assembly movable along the respective frame, each rack portion having a protrusion extending outwardly from a surface of the rack portion for supporting a reel, and a locking mechanism attached to each of the frames for locking in place the rack portion carrying the reel, the locking mechanism includes a plunger shaft that engages a portion of the rack portion to lock/unlock the plunger shaft against the rack portion, the plunger shaft being surrounded by a guard member that includes an opening In a first position, the plunger shaft is configured to be slidable to display a first indicator that is viewed through the opening of the guard member, indicating a locked state. In a second position, the plunger shaft is configured to be slidable to display a second indicator that is viewed outside of the guard member, indicating an unlocked state.

### REFERENCE TO RELATED APPLICATIONS

The application claims priority to U.S. provisional application 63/667,967, filed Jul. 5, 2024, entitled “Pinless Reel Trailer Locking Mechanism” and U.S. provisional application 63/815,032, filed May 30, 2025, entitled “Pinless Reel Trailer Locking Mechanism with Safety Latch,” the entire contents of each of which are hereby incorporated by reference herein.

### TECHNICAL FIELD

The present disclosure relates to a pinless reel trailer; more specifically, a pinless reel trailer with a locking mechanism.

### BACKGROUND

Vehicles or trailers pulled behind vehicles often utilize frames that support rack assemblies adapted to hold any number of things, such as cable reels, with the frames having power sources for vertically raising/lowering the cable reels as needed by the operator. For many reasons, notably for safety, the rack assembly supporting the cable reels needs to be secured to the frame while the vehicle or trailer is traveling. Typically, pins, such as quick release pins are either secured to the frame by lanyards, if they are secured at all. Moreover, even if the power source is utilized to position the rack assembly at its “travel position,” prior to traveling, users may forget to inset the pins into the rack assembly and frame, potentially placing the user or others at risk, for reasons including not only that the cable reels are not properly secured, but the possibility of the uninstalled pins falling from the vehicles or trailers at highway speeds, or ends of fallen pins protruding upwardly after coming to rest on or along the side of the road capable of puncturing tires or resulting in other damages/injuries to motorists/passersby.

Moreover, current systems have no manner of indicating that the reels are properly secured and locked on the rack assembly. In some occasions, the user approaches the back of the trailer and applies a force on the rack assembly to ensure that reel does not move and properly locked. This process is cumbersome and can cause injury to the user.

In view of the problems associated with these systems using pins, there remains a need to provide a pinless reel trailer with a locking mechanism that does not suffer from these deficiencies.

### SUMMARY

In an exemplary embodiment, a pinless reel trailer includes a pair of frames, each frame for supporting a corresponding portion of a rack of a rack assembly movable along the respective frame, each rack portion having a protrusion extending outwardly from a surface of the rack portion for supporting a reel, and a locking mechanism attached to each of the frames for locking in place the rack portion carrying the reel, the locking mechanism includes a plunger shaft that engages a portion of the rack portion to lock/unlock the plunger shaft against the rack portion, the plunger shaft being surrounded by a guard member that includes an opening In a first position, the plunger shaft is configured to be slidable to display a first indicator that is viewed through the opening of the guard member, indicating a locked state. In a second position, the plunger shaft is configured to be slidable to display a second indicator that is viewed outside of the guard member, indicating an unlocked state

In another exemplary embodiment, a pinless reel trailer includes a pair of frames, each frame for supporting a corresponding portion of a rack of a rack assembly movable along the respective frame, each rack portion having a protrusion extending outwardly from a surface of the rack portion for supporting a reel, and a locking mechanism attached to each of the frames for locking in place the rack portion carrying the reel, the locking mechanism includes a plunger shaft, surrounded by a guard member, having a first end that engages a portion of the rack portion to lock the plunger shaft against the rack portion and a second end attached to a handle. In response to an application of force to the handle, the handle disengages with the guard member, permitting movement of the plunger shaft towards and away from the rack portion

Other features and advantages of the present invention will be apparent from the following more detailed description of the preferred embodiment which illustrates, by way of example, the principles of the invention.

### BRIEF DESCRIPTION OF THE DRAWINGS

FIG. 1 is an upper perspective view of an exemplary trailer or vehicle, according to an example embodiment of the present disclosure.

FIG. 2A is a side elevation view of the trailer of FIG. 1 in a first position, according to an example embodiment of the present disclosure.

FIG. 2B is a side elevation view of the trailer of FIG. 1 in a second position, according to an example embodiment of the present disclosure.

FIG. 3A is an enlarged partial upper perspective view of the trailer of FIG. 1, according to an example embodiment of the present disclosure.

FIG. 3B a partially exploded view of the trailer of FIG. 3B, according to an example embodiment of the present disclosure.

FIG. 4 is an enlarged partial perspective view of a frame member of FIG. 1, according to an alternative example embodiment of the present disclosure.

FIGS. 5A-5M are sequential views showing the operation of a locking mechanism of FIG. 1, according to an example embodiment of the present disclosure.

FIG. 6 is an upper perspective view of an exemplary trailer or vehicle, according to another example embodiment of the present disclosure.

FIG. 7 is an enlarged partial perspective view of a frame member of FIG. 6, according to an alternative example embodiment of the present disclosure.

FIGS. 8A-8M are sequential views showing the operation of a locking mechanism of FIG. 6, according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

The present disclosure relates to a pinless reel trailer that secures a reel of a cable on the trailer and provides immediate user feedback through use of visual aid. Unlike conventional systems, these systems use pinned reel trailers which is a potential safety hazard.

Further, the present disclosure relates to a pinless reel trailer with a locking mechanism that secures the reel trailers' reel bar with indicators to show the user if the trailer is safe to transport or not. The design has some mechanical automation that helps ensure proper engagement and securement of the system. Additionally, this design ensures additional safety measures and improved ease of use, which is an improvement over previous systems.

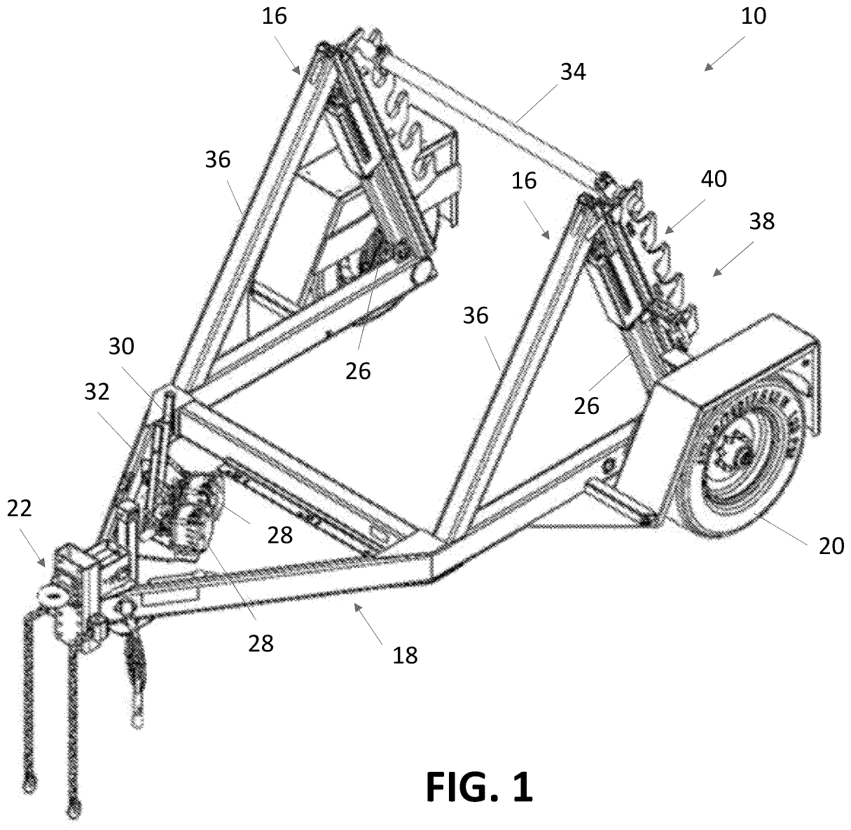

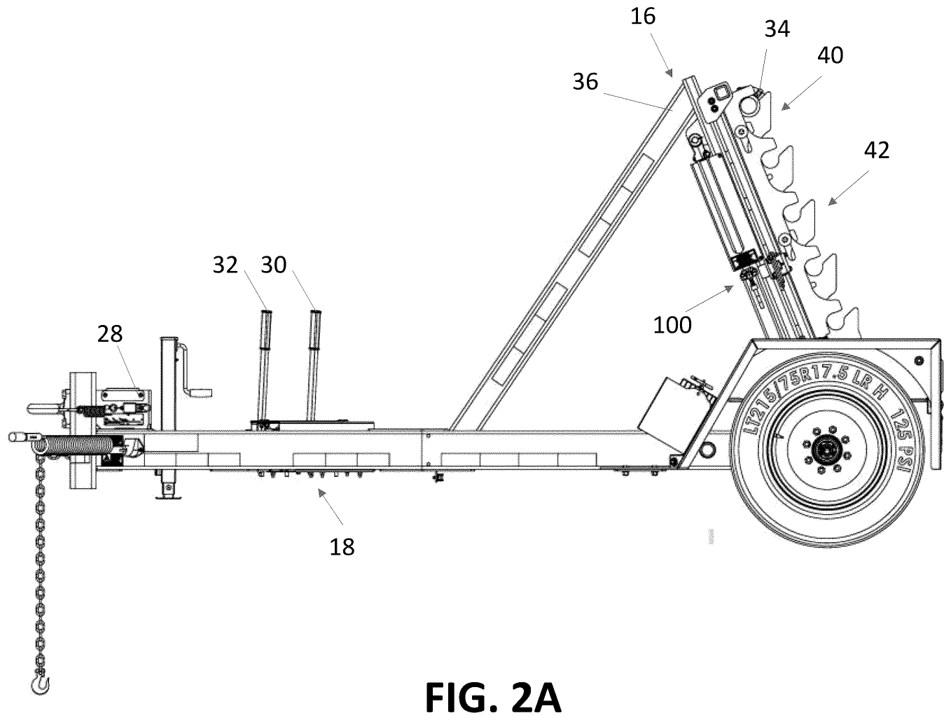

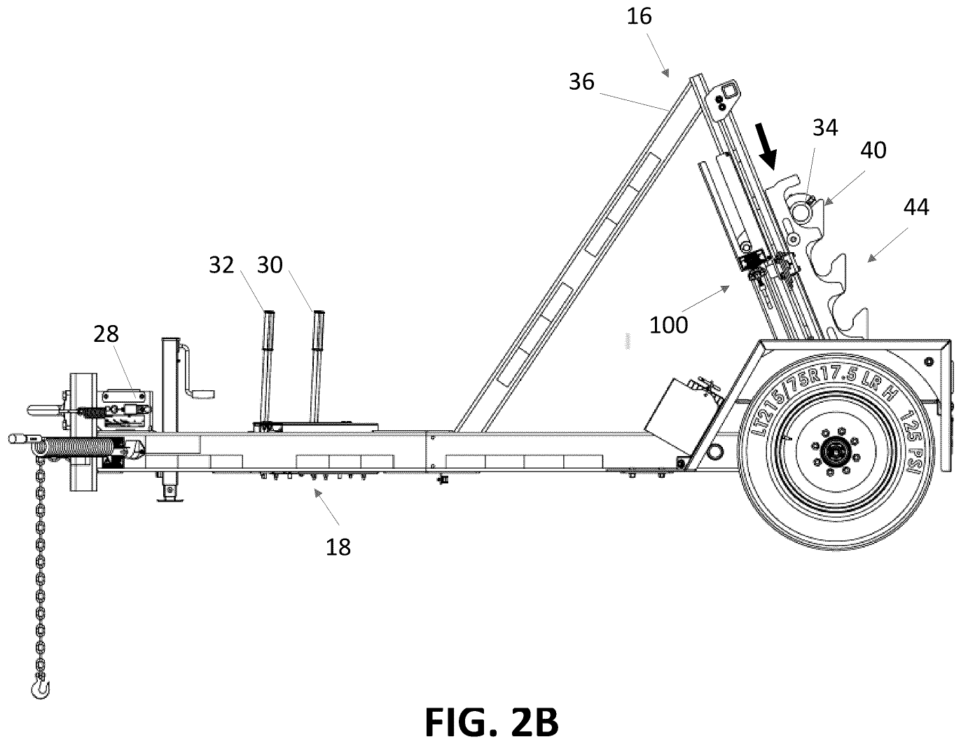

Referring now to the figures, FIG. 1 illustrates an exemplary trailer 10 for transporting articles such as reels of cable for power transmission or other uses. As shown, trailer 10 includes a pair of frames 16 such as arranged to define a pair of inverted V-shaped frames 36 movably supporting a rack assembly 38 between a first (travel) position 42 (FIG. 2A) and a second (lowered) position 44 (FIG. 2B) utilized to more easily access the article, permitting work to be performed while the trailer 10 is not moving. Trailer 10 includes a trailer frame 18 for supporting frames 16, wheel 20 rotatably connected to trailer frame 18, and a hitch 22 permitting the trailer 10 to be pulled behind a vehicle (not shown). In other implementations, frames 16 may be supported by a support frame (not shown) of a vehicle, and not requiring a pull-behind trailer arrangement.

The rack assembly 38 includes a pair of opposed rack portions 40 supporting opposed ends of a roller 34 for carrying articles such as cable reels or other hollow cylindrically shaped articles or suitably configured articles. As shown, levers 30, 32 are operably connected to a power source 28, such as pressurized fluid for actuating or moving a pair of actuators 26 between the first position 42 and the second position 44. Alternately, power source 28 may be provided by an electrical motor, a mechanical motor, a mechanical linkage, or combination thereof. The levers 30, 32 are independently operated to move the rack assembly 38 along the corresponding frames 36. In some implementations, the levers 30, 32 can be bi-directional to move the rack assembly 38 up or down. In other words, the power source 28 operates the rack assembly 38 (either up or down) controlled by the levers 30, 32. In other implementations, the levers 30, 32 can be configured to be uni-directional to move the rack assembly 38. For example, the levers 30, 32 can be used to move the rack assembly 38 in an upward direction and gravity for the down direction.

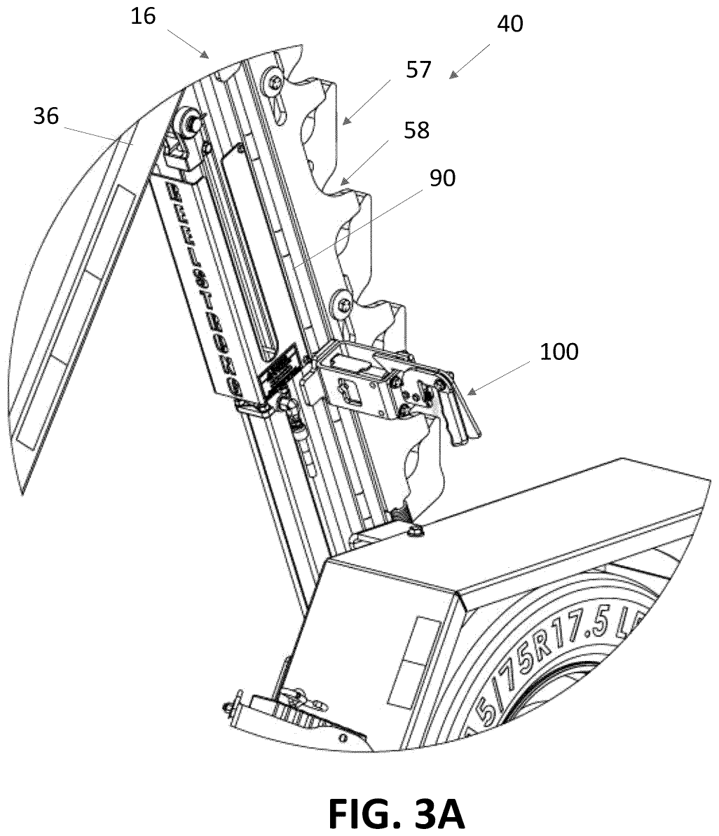

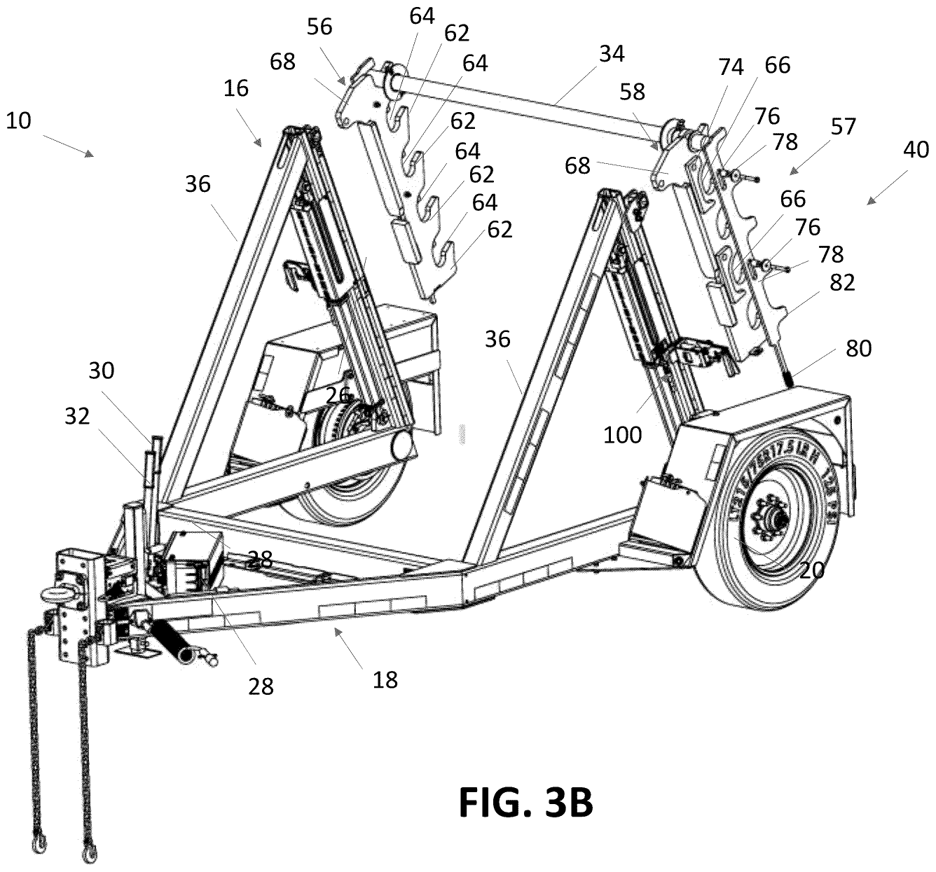

FIG. 3A shows a partially view of rack portion 40 and FIG. 3B shows a partially exploded view of rack portion 40 for clarity. As further shown in FIG. 3B, rack portion 40 includes a rack member 56 having an elongate head 58 having an aperture for receiving an end of the actuator 26, in which the rack member 56 includes a plurality of hooks 62 having corresponding recesses 64 positioned at the base of each hook 62. As shown, head 58 of rack member 56 further includes a protrusion 68 such as a generally rectangular block extending outwardly from a surface 70 of rack member 56, and an aperture 72 formed near protrusion 68. A pair of spacers 66 slidably separate rack member 56 from a rack member 57, each spacer 66 having a threaded aperture 74 for threadedly receiving a fastener 76 therein, whereby the relative sliding movement between rack members 56, 57 limited by the opposed ends of slots 78. A spring 80 urges retainers 82 of rack member 57 toward their corresponding hooks 62, the corresponding retainers 82 and hooks 62 forming pockets therein for receiving a corresponding end of the roller 34 (FIG. 3A). A stop 86 secured to frame 16 abuts the top of rack member 57 when rack portion 40 is at travel position 42, ensuring that corresponding hooks 62 and retainers 82 of respective rack members 56, 57 are secured relative to one another.

As further shown in FIG. 3A, a locking mechanism 100 is attached to the frame 36 for automatically locking the reel in place for stability and safety. In other words, while the rack portion 40 is configured to move up or down, the locking mechanism 100 locks in place and secures the reel at various predetermined positions. The locking mechanism 100 has a first indicator 101 indicating that the rack portion 40 is secured or locked and safe for travelling and a second indicator 103 indicating that the rack portion 40 is not secured or locked and unsafe for travelling. In some implementations, the first and second indicators 101, 103 can be color indicators. For example, the first indicator 101 can be the color green while the second indicator 103 can be color red. In some implementations, the first and second indicators 101, 103 can be patterned. For example, the first indicator 101 can have “O” marking(s) and the second indicator 103 can have “X” marking(s). In other implementations, the first and second indicators 101, 103 can have images or graphics. For example, the first indicator 101 can have a permission sign (e.g., a check mark image) and the second indicator 103 can have a warning sign (e.g., a circle with a slash image). In other example, the first indicator 101 can have the word “GO” and the second indicator 103 can have the word “STOP”. It should be appreciated that other indicators can be employed, and not limited to the ones described herein. This enables feedback through use of visual aid and immediate user feedback that the trailer is safe to travel, providing security and ensuring the reel is locked.

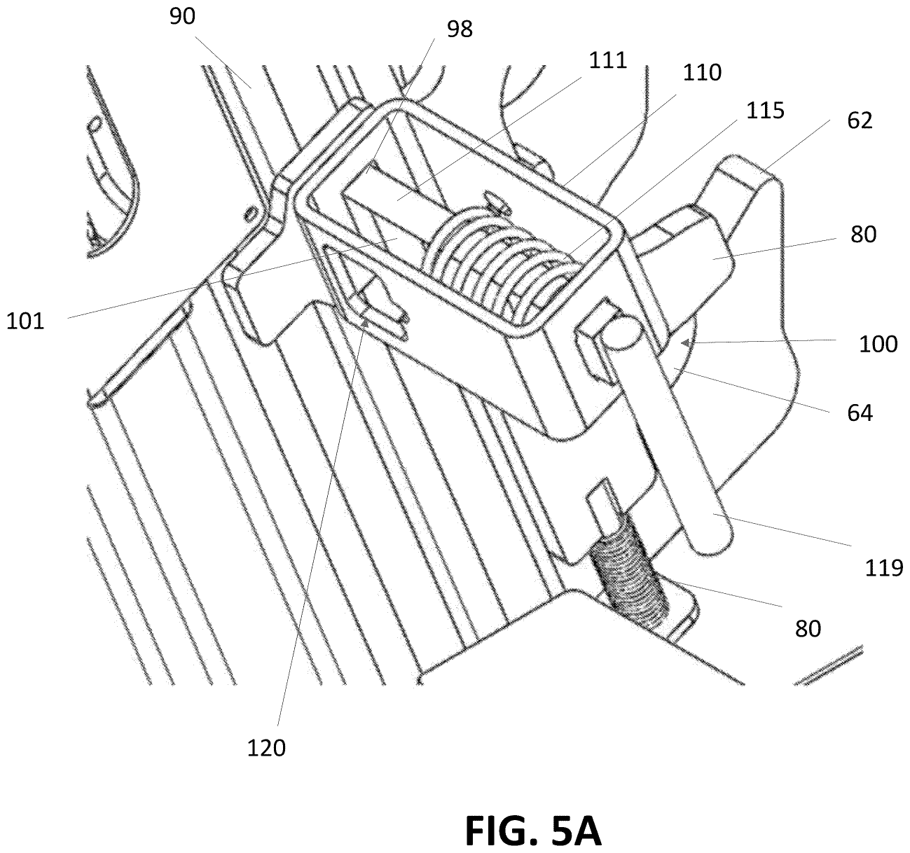

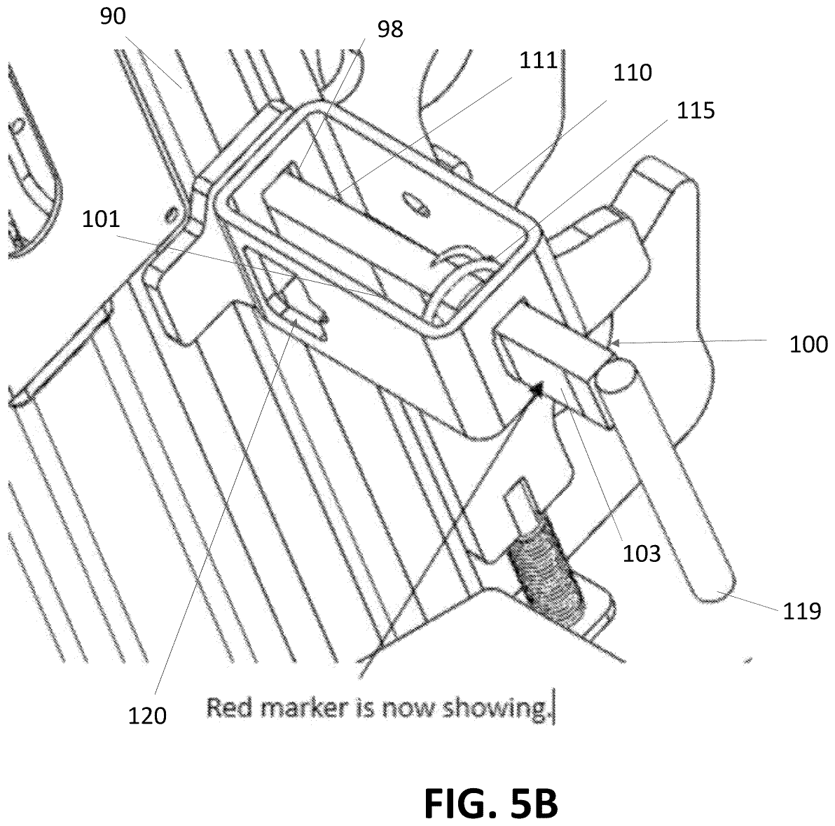

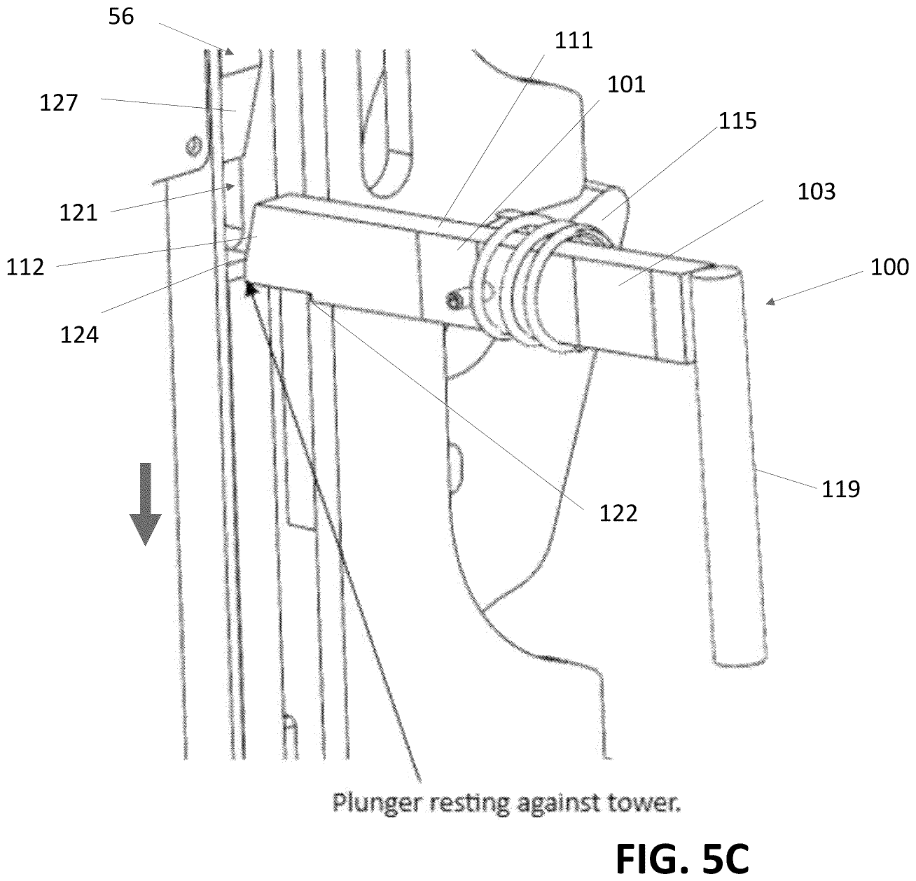

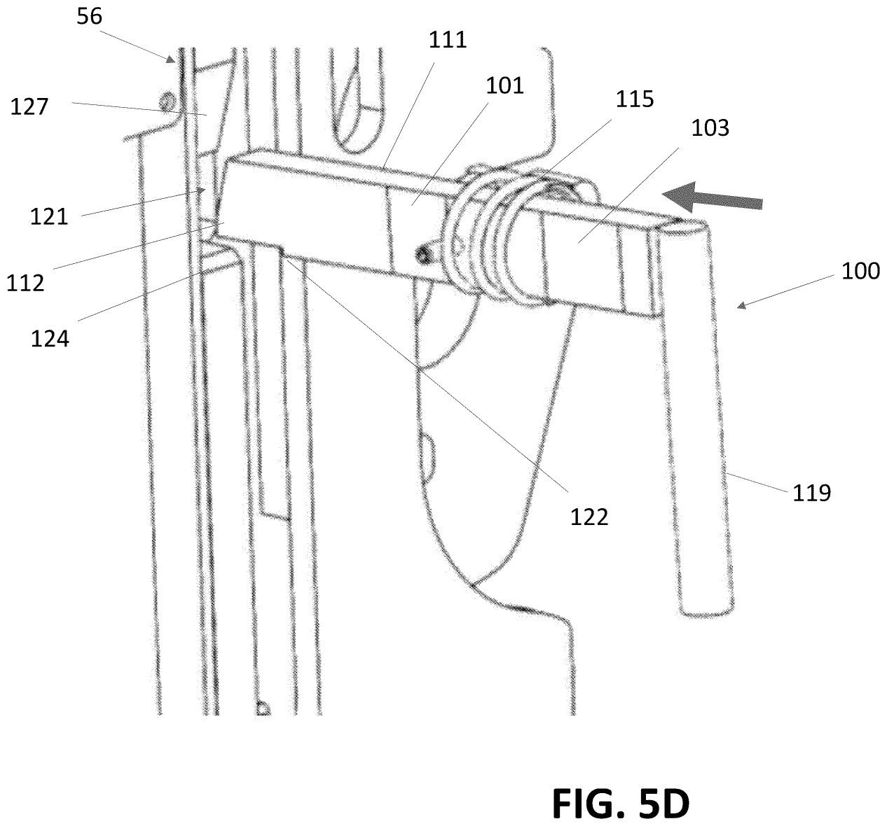

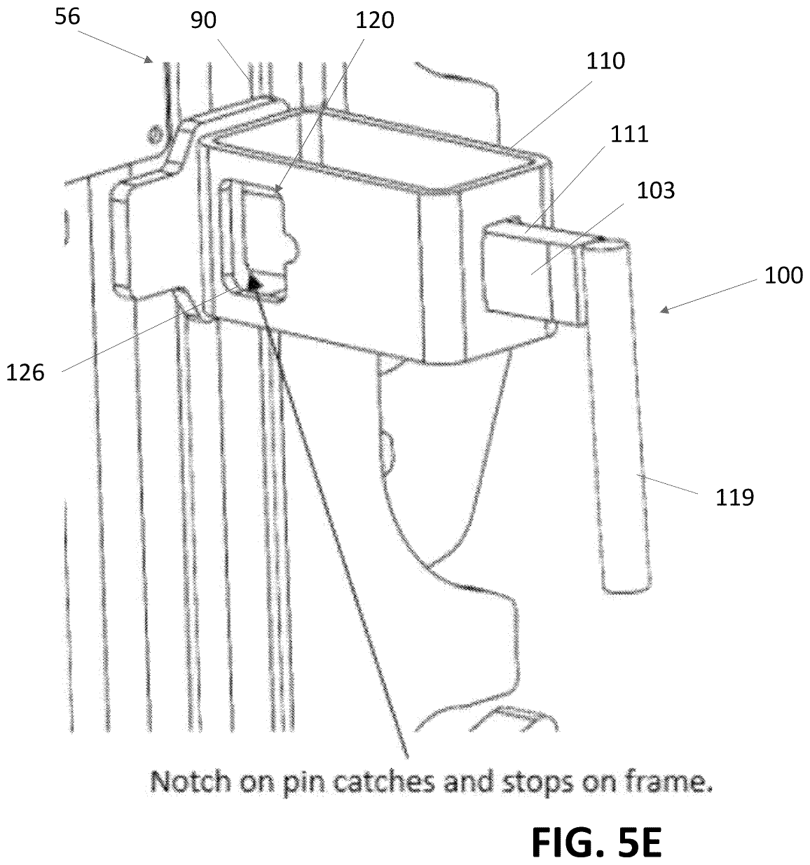

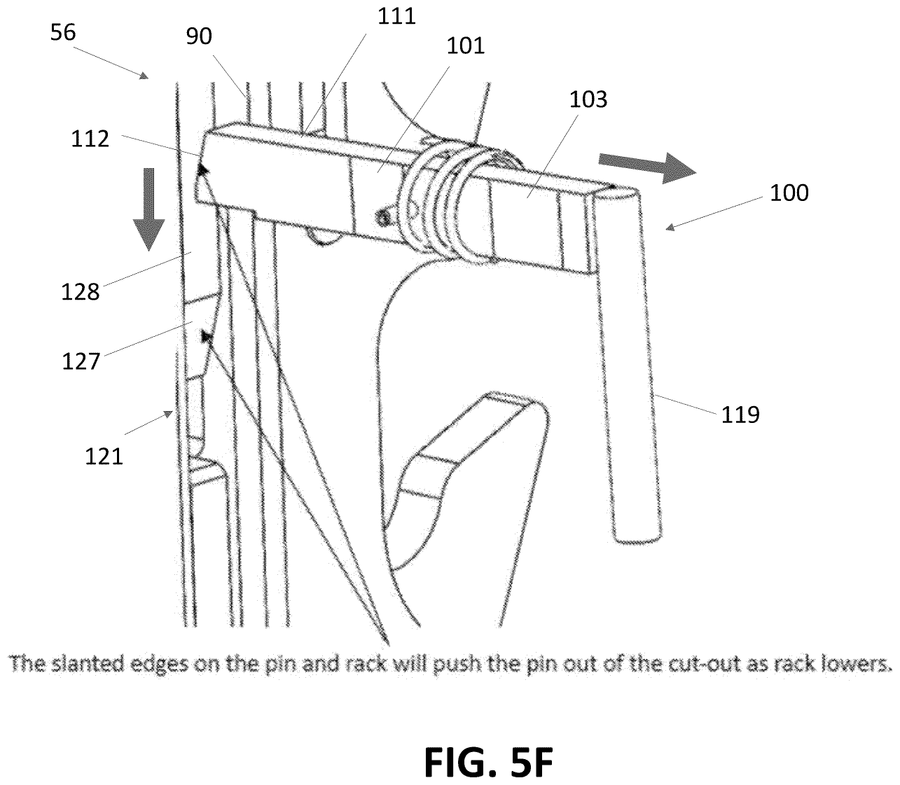

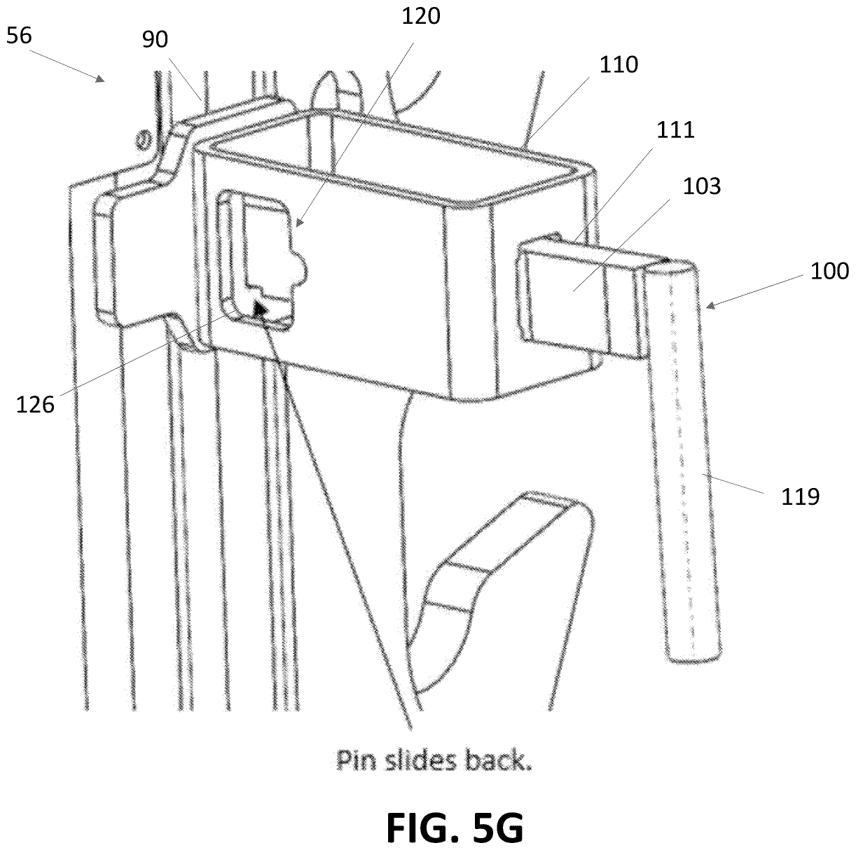

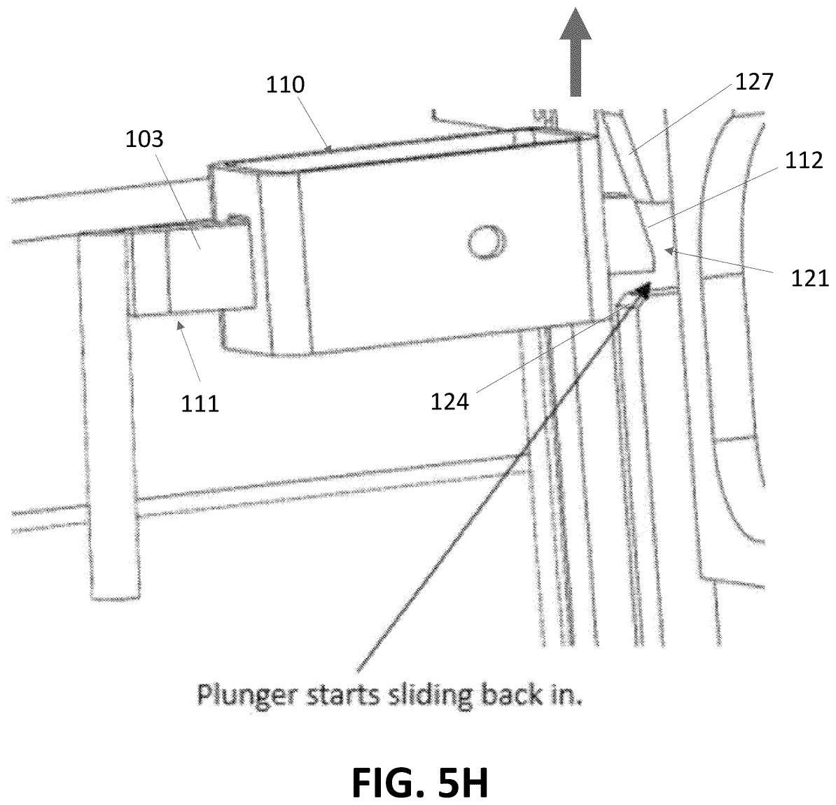

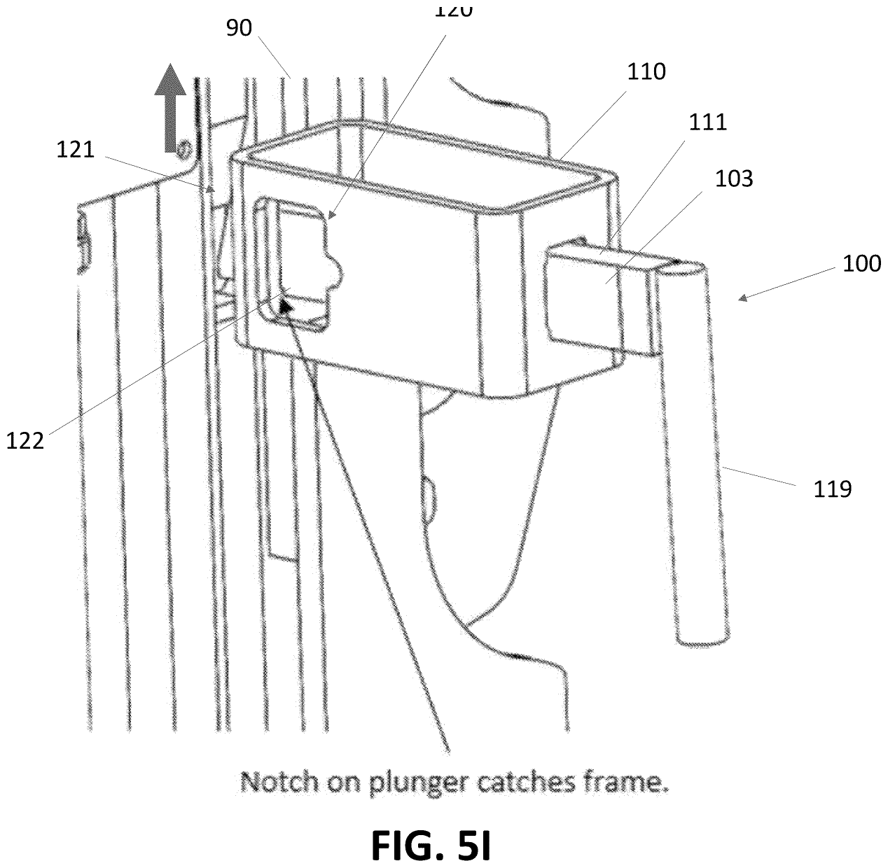

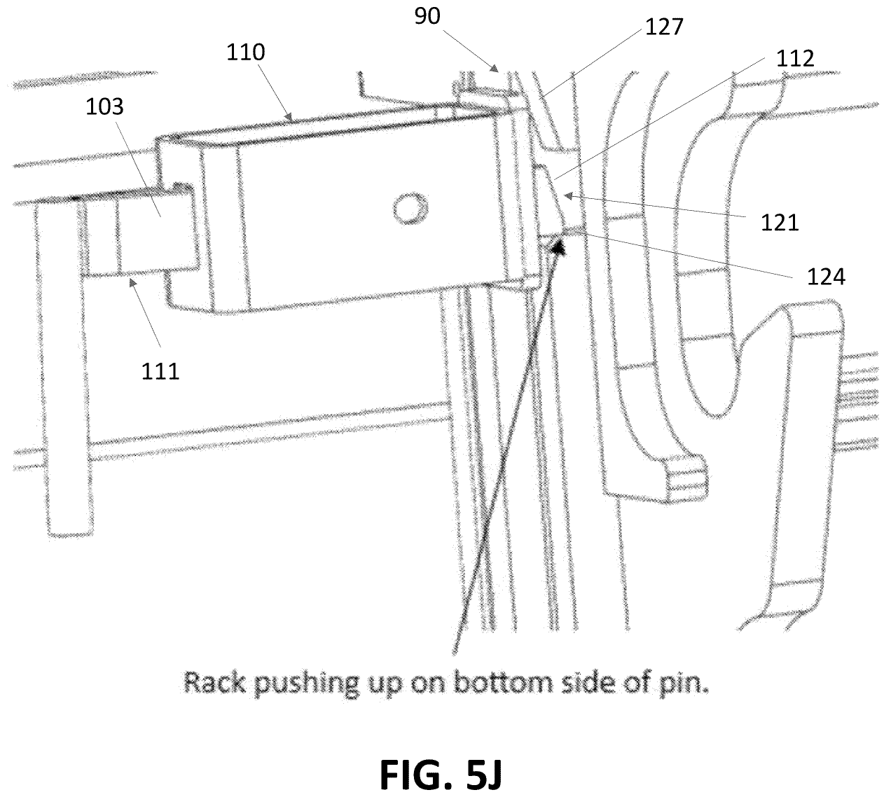

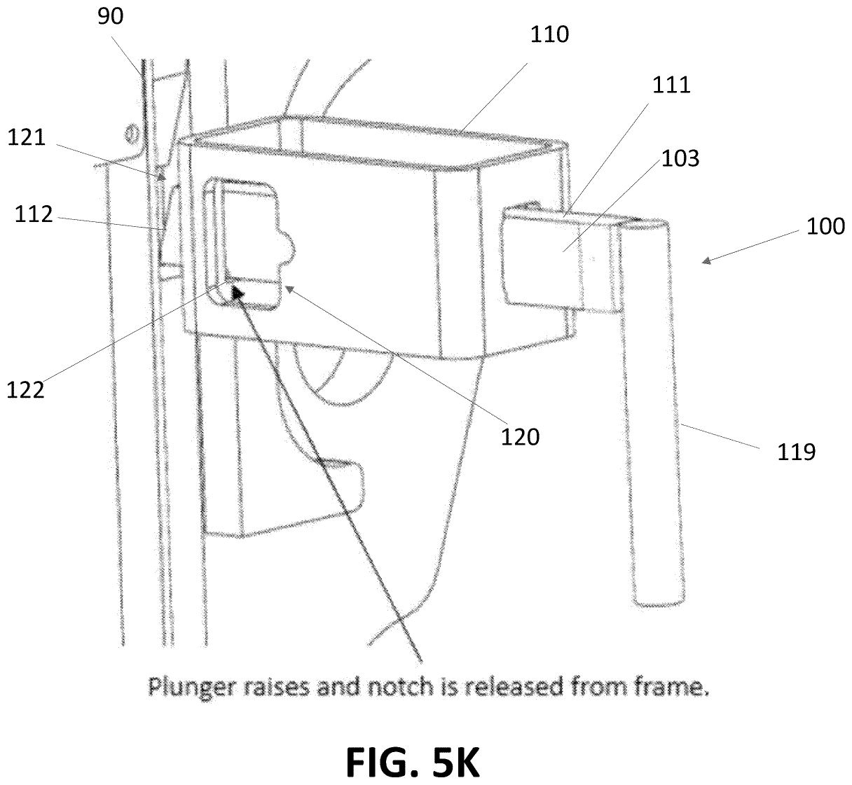

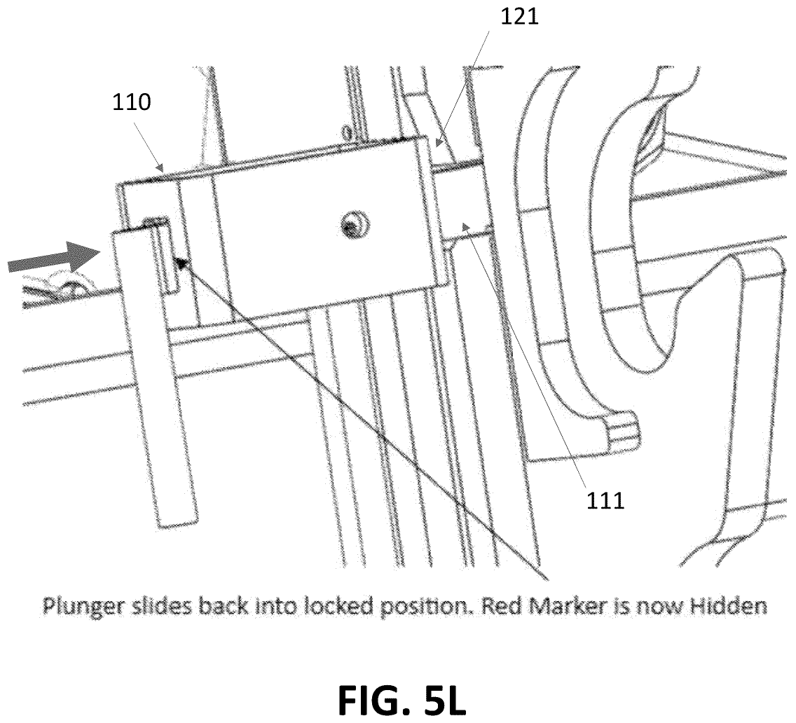

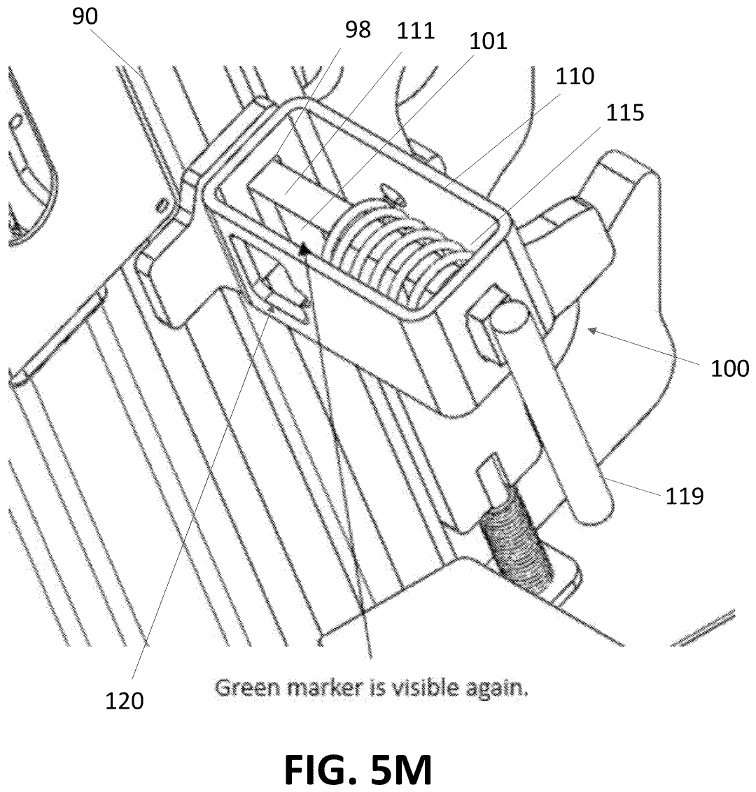

The locking mechanism 100 includes a guard frame 110 to safeguard and surround a plunger shaft 111 that is configured to engage with rack member 56 of rack portion 40, which will be described in detail later. More specifically, the plunger shaft 111 is configured to slide in and out (or extends inside) of an aperture 98 to lock the rack portion 40 in place. At an end 112 of plunger shaft 111 (FIG. 5C), a slanted edge is formed to engage with a portion of the rack portion 40 to assist in moving the plunger shaft 111. More specifically, end 112 is configured to engage a corresponding portion 127 (FIG. 5C) formed on the rack member 56, which moves the plunger shaft 111 in and out of a cut-out portion 121 of rack member 56. In a fully engaged position, the rack portion 40 is secured to frame 16. As further shown in FIG. 5A, a spring 115 surrounds the plunger shaft 111 which is configured to move in a compressed state and an uncompressed state. It is appreciated that the spring 115 is of a convention spring known in the art that produces the appropriate force for engaging the plunger shaft 111 against the rack member 56 of the rack portion 40. Other devices may be employed, such as, for example, gas cylinder springs, hydraulic springs, and the like. The plunger shaft 111 further includes a pin 117 that holds the spring 115 pressure thereof (FIG. 5C). The pin 117 engages with the spring 115 and pulls (or holds) a portion of the spring 115 back, providing the spring 115 in a compressed state. To describe differently, in the locked state of the locking mechanism 100, the pin 117 is positioned near frame member 90 and engages with the spring 115. Conversely, in the unlocked state, the pin 117 moves away from frame member 90 and disengages with the spring 115 and releases the spring 115 into an uncompressed state. A handle 119 is attached at an end 118 of the plunger shaft 111 to release or disengage the plunger shaft 111 against the rack member 56 of the rack portion 40. It should be appreciated that different spring arrangements that may be positioned differently are contemplated by the present disclosure.

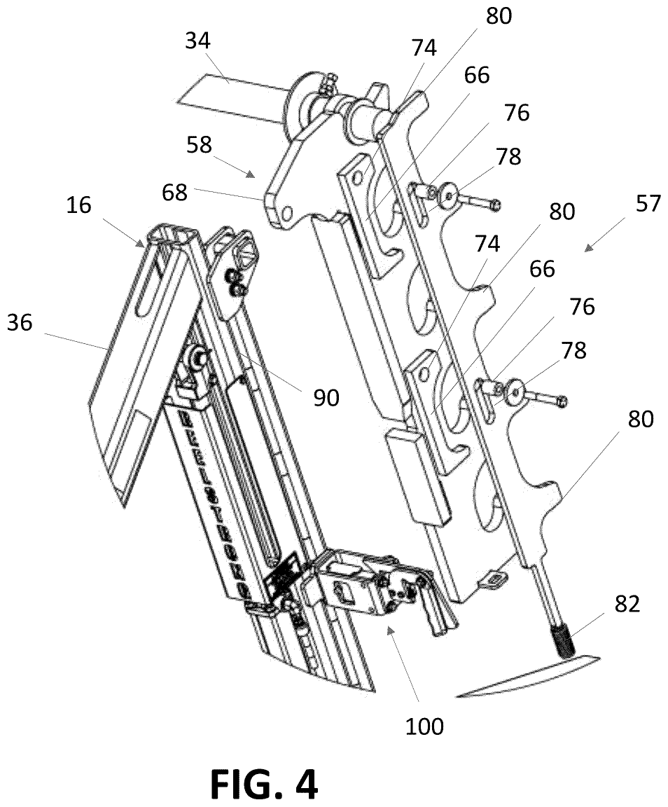

Referring to FIG. 4, frame 16 defines an inverted V-shaped frame comprising frame member 36 corresponding to one leg of the inverted V-shaped frame that is secured at mutual ends to frame members 90, 92 that are secured together to form the other leg of the V-shaped frame. As shown, frame 16 further includes the locking mechanism 100 attached to frame member 90. The locking mechanism 100 is attached to the frame 36 by fasteners (e.g., bolts, screws, rivets, and various specialized fasteners like threaded inserts and self-drilling screws). Other fastening methods such as welding, brazing, and soldering can be employed. Further, frame member 90 includes a pair of aligned slots 94 for slidably receiving head 58 of rack member 56 as actuated or moved by actuator 26 (FIG. 3A or 3B). FIG. 4 further shows the locking mechanism 100 in a fully engaged state in frame 16, with the plunger shaft 111 extending through the aperture 98, then through an open space inside of frame member 90. More specifically, end 112 of plunger shaft 111 extends through the aperture 98 and engages a portion of rack member 56 of rack portion 40. In this fully engaged state, rack portion 40 is secured to frame 16 at this position. As further shown in FIG. 5A, the guard frame 110 includes an opening 120 to visually display whether the plunger shaft 111 is in a locked state or an unlock state. To describe differently, when the plunger shaft 111 is in a locked state, the plunger shaft 111 moves accordingly (towards the frame 90) and displays the first indicator 101 through the opening 120. By way of example, the first indicator 101 is the color green indicating that the plunger shaft 111 is in a locked state and safe to travel. On the other hand, if the plunger shaft 111 is in an unlocked state, the plunger shaft 111 moves in an opposite direction and hides the first indicator 101 from view of the opening 120, and instead, the second indicator 103 is displayed outside of the guard frame 110 (FIG. 5B). By way of example, the second indicator 103 is the color red indicating that the plunger shaft 111 is in an unlocked state and not safe for travelling.

FIGS. 5A-5M are sequential views showing the operation of the locking mechanism 100 between a locked/engaged state and an unlocked/disengaged state. Stated another way, these operational sequences show how the locking mechanism 100 transitions from the locked position in which the plunger shaft 111 is engaged with the rack member 56 of the rack portion 40 (FIG. 5A) to an unlocked position in which the plunger shaft 111 is disengaged with the rack member 56 of the rack portion 40 (FIG. 5B). Each of the rack portions 40 are simultaneously subjected to the same operations, and thus, only one side is shown and discussed.

Referring to FIG. 5A, a force caused by the spring 115 urges the plunger shaft 111 to move in a direction towards the frame 90 (via aperture 98) and engage a portion of the rack member 56. As shown, this illustrates the plunger shaft 111 in a locked or closed position so that the rack portion 40 cannot move. This in turn provides the first indicator 101 to be displayed or viewed through the opening 120 illustrating that the plunger shaft 111 is locked and ready for traveling. In conjunction, the second indicator 103 has moved inside (or behind) of the guard frame 110, which in turn hides the second indicator 103 from view. In order to release the plunger shaft 111 from its locked position, the plunger shaft 111 is pulled in a direction away from a cut-out 127 formed in the rack member 56 via the handle 119 until an end of the plunger shaft 111 tilts forward and rests against a portion 124 of the rack member 56 (FIG. 5C). Then, while the rack member 56 is being lowered, the plunger shaft 111 begins to reverse direction and move back towards the rack member 56 until a notch 122 (formed on a lower side of the plunger shaft 111) rests on (or abuts against) an edge portion 126 of the frame 90 (FIG. 5E). As the rack member 56 continues to be lowered, the plunger shaft 111 then starts to catch and stop on a portion of the rack member 56, disengaging the rack member 56. As shown, the slanted end 112 pushes the plunger shaft 111 out of the cut-out portion 121 as the rack member 56 is lowered and abuts against a portion 128 of rack member 56, disengaging the plunger shaft 111 from the rack member 56 (FIG. 5F). This in turn moves the plunger shaft 111 in a direction away from the rack member 56 for displaying the second indicator 103 while hiding the first indicator 101. Due to the end 112 and the portion 127 being of the same angle, the plunger shaft 111 correspondingly engages with respect to portion 127 in only one direction. After the rack member 56 is set to its desired position so as to load the reel onto the roller 34, the rack member 56 begins to move upward and the plunger shaft 111 begins to slide eventually back into the cut-out portion 121 until the notch 122 again engages the edge portion 126 of the frame 90 (FIG. 5I). In other words, the plunger shaft 111 moves in a direction towards the rack member 56 until the notch 122 abuts against the edge portion 126 of the frame 90. While the rack member 56 continues to move upwards, the plunger shaft 111 begins to move (slide) into the cut-out portion 121 of the frame 90 (FIG. 5H) to be locked. Because the rack member 56 continues to move upwards and pushes up on the bottom of the plunger shaft 111, this releases the plunger shaft 111 from the frame 90, which slides the plunger shaft 111 into eventually into the locked position (FIG. 5J). In addition, while the plunger shaft 111 is moving upwards, the notch 122 is released from the frame 90 (FIG. 5K). Then, the plunger shaft 111 slides back in the locked or engaged position. This in turn moves the plunger shaft 111 back into the cut-out portion 121, in which the first indicator 101 is displayed through the opening 120 while the second indicator 103 is hidden from view (FIG. 5L) and returned back to its locked state (FIG. 5M).

In use, referring again to FIGS. 5A-5M, the user operates the locking mechanism 100 by initially pulling the handle 119 towards the user to release the locking mechanism 100 from its locked position. The handle 110 forces the end 112 of the plunger shaft 111 to tilt slightly forward until the end 112 rests against the portion 124 of the rack member 56. The user then operates the levers 30, 32 operably connected to the power source 28 (e.g., pressurized fluid) to actuate the pair of actuators 26 to move the rack member 56 in a downward direction. While the rack member 56 is being lowered, the plunger shaft 111 begins to reverse direction and move back towards the rack member 56 until the notch 122 abuts against the edge portion 126 of the frame 90, preventing the plunger shaft 111 from moving farther into the cut-out portion 121. As the rack member 56 is further lowered, the slanted edge 112 of the plunger shaft 111 pushes the plunger shaft 111 out of the cut-out portion 121 (towards the user) to fully disengage or in an unlocked state. Once the appropriate level for the rack assembly 38 is set to install the reel on the rack assembly 38, the user operates the levers 30, 32 to operatively move the rack member 56 in an upward direction. While the rack member 56 continuingly moves upward, the plunger shaft 111 begins to slide back towards the cut-out portion 121 until the notch 122 abuts against portion 126 of the frame 90, preventing it from further movement. Then, the rack member 56 pushes up on the bottom side of the plunger shaft 111, which will release the plunger shaft 111 from the frame 90 and cause the plunger shaft 111 to slide towards the cut-out portion 121 for the locked position. This causes the plunger shaft 111 to slightly rise so that the notch 122 is released from portion 126 of frame 90. The plunger shaft 111 continues to slide towards the cut-out portion 121 until the plunger shaft 111 is fully locked against in the rack member 56. As a result, the first indicator 101 is displayed or viewed through the opening 120 indicating that the plunger shaft 111 is locked and the reel secured and ready for traveling. This locking operation is fully automated so that harm or injury to the user can be avoided.

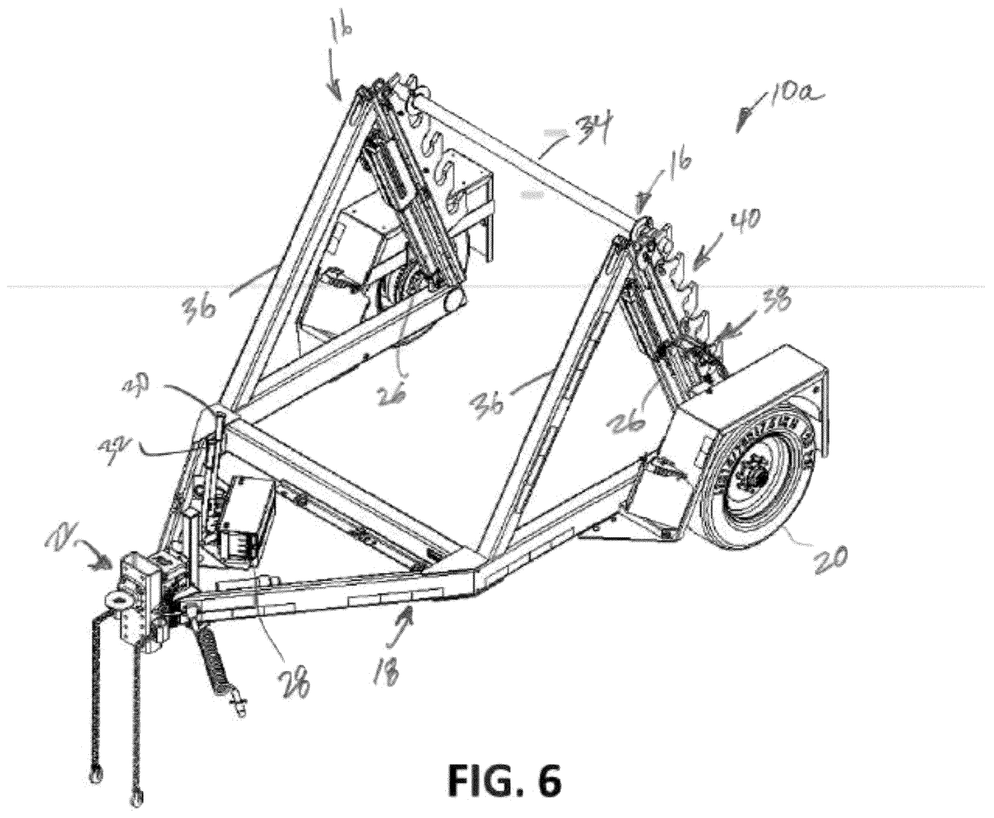

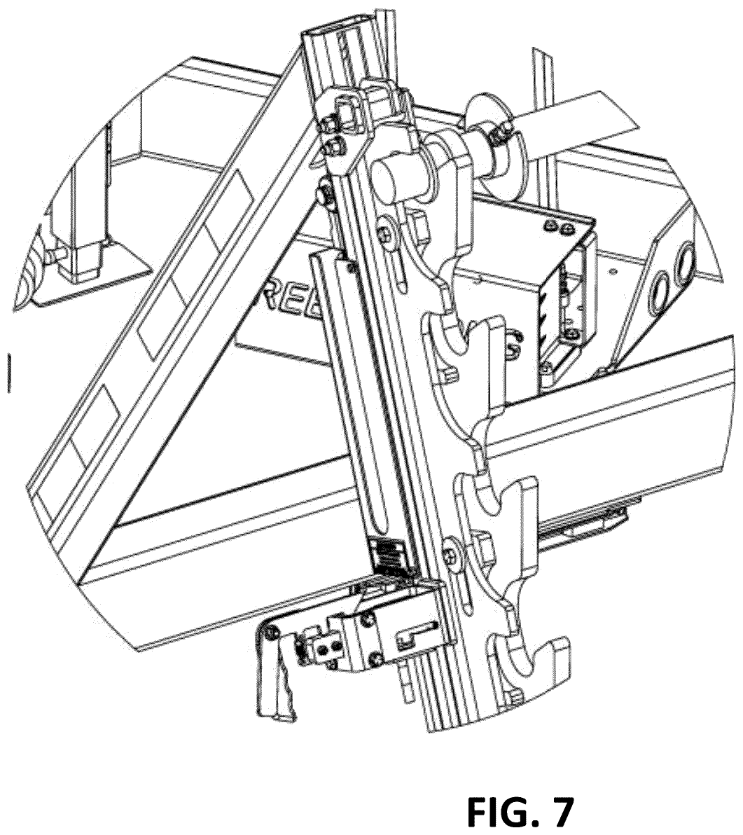

FIG. 6 illustrates another exemplary trailer 10a for transporting articles such as reels of cable for power transmission or other uses. Trailer 10a of FIG. 6 is similar to trailer 10 of FIG. 1 except for a different locking mechanism 200, which will be described in detail herein. Like numerals will be used for similar elements and will not be fully described in this section.

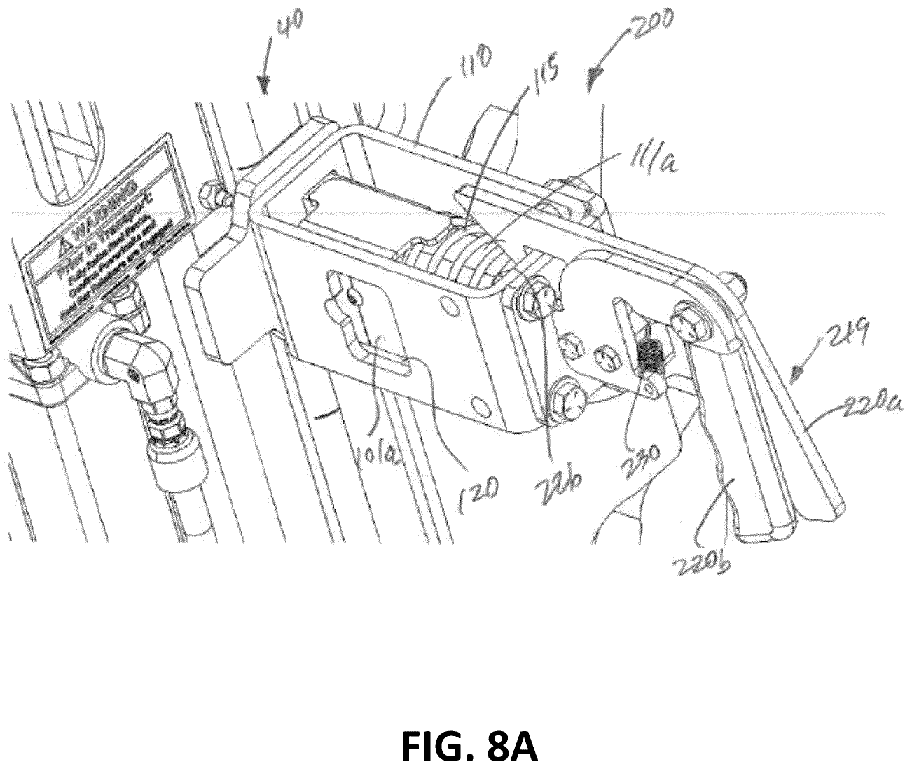

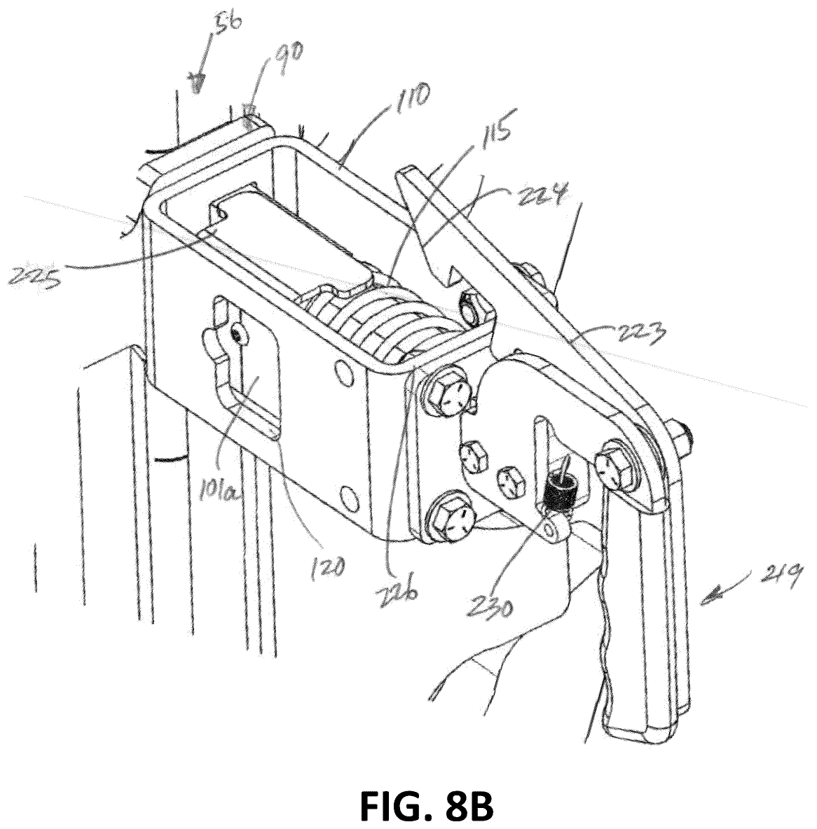

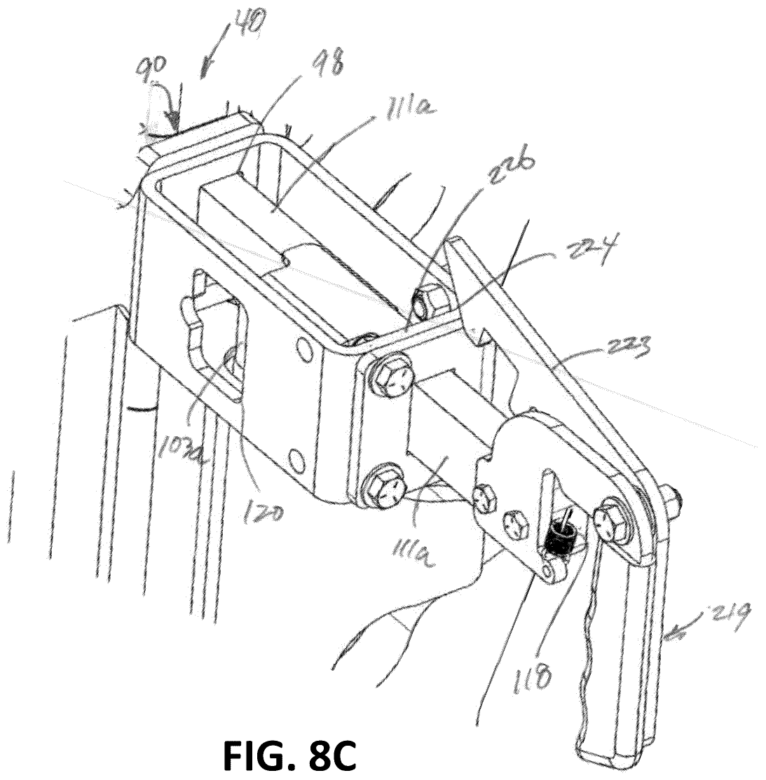

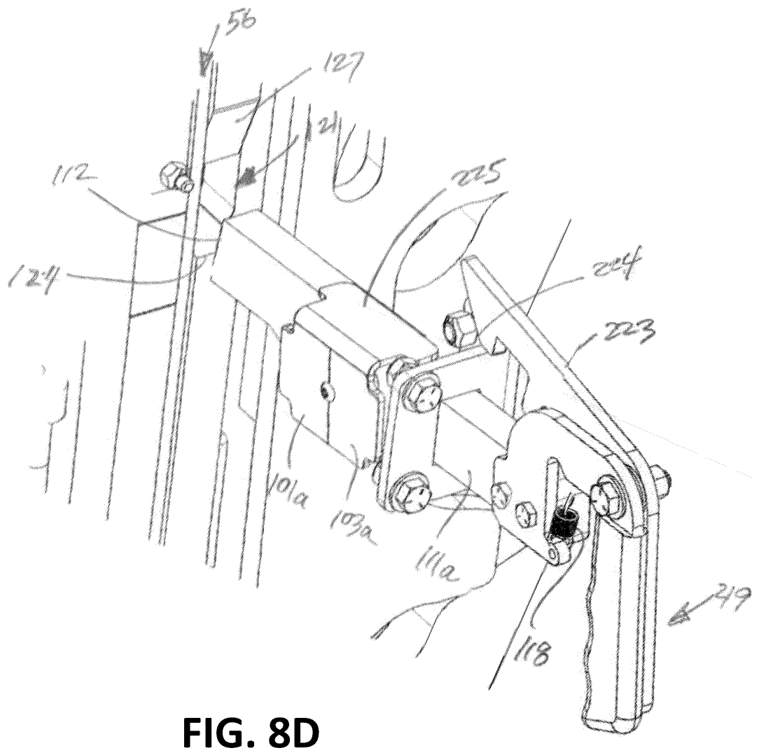

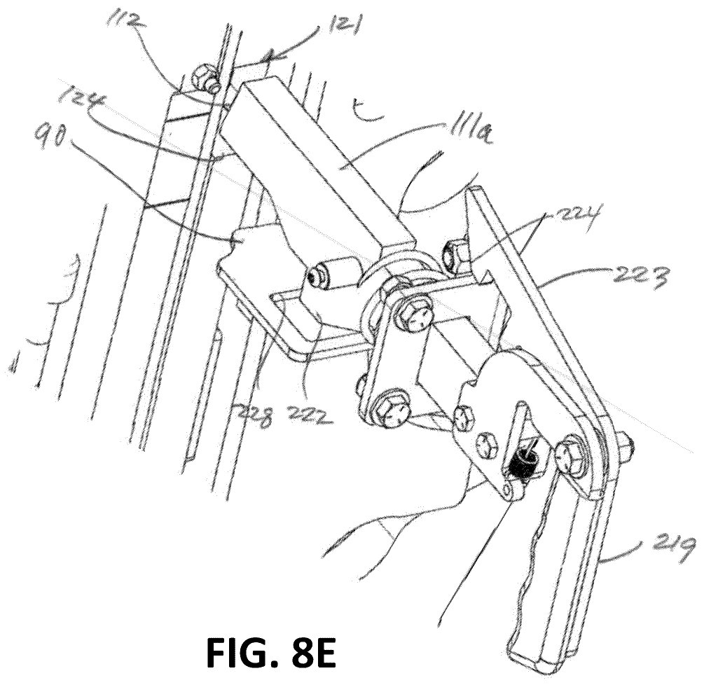

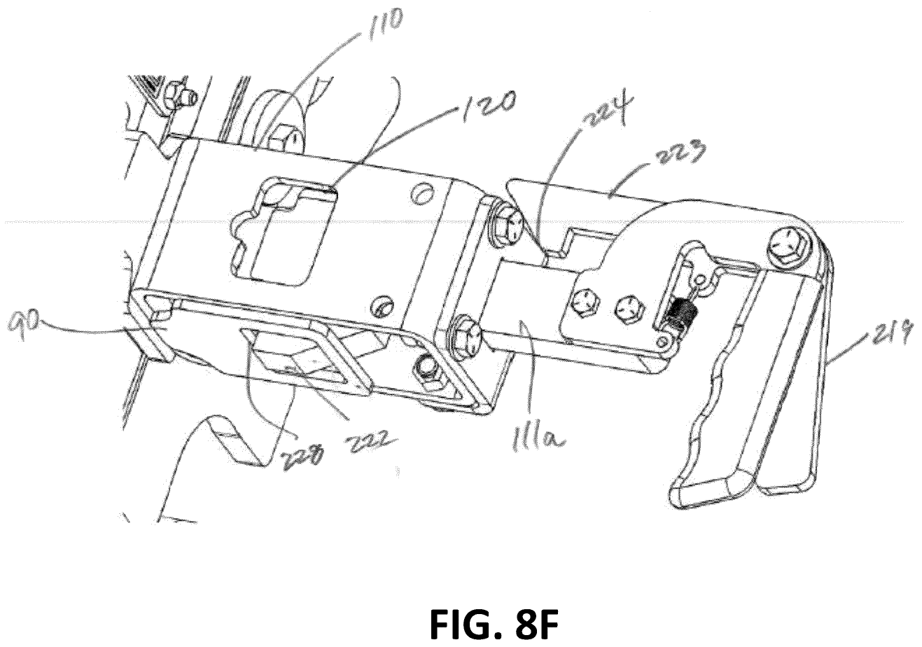

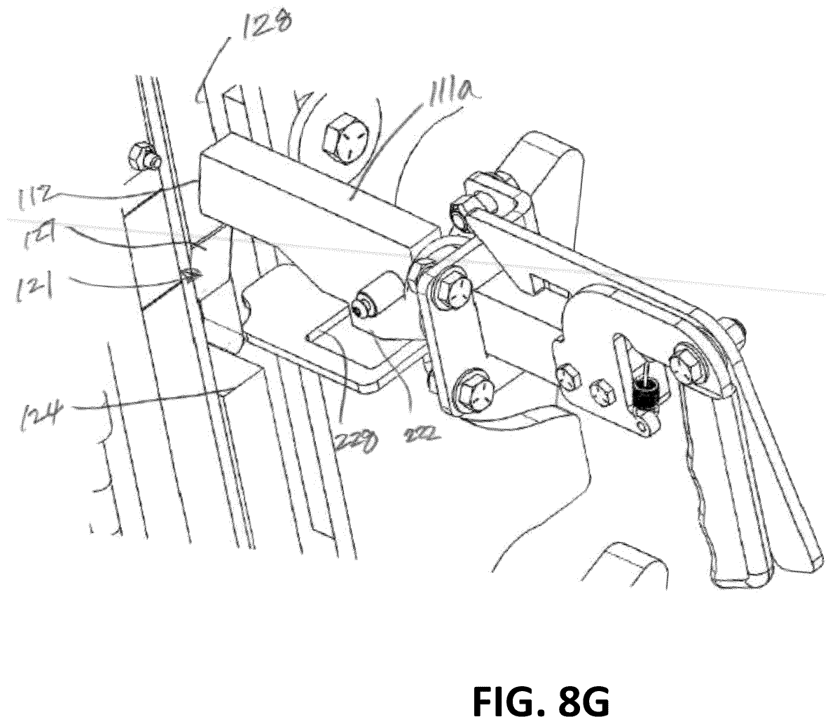

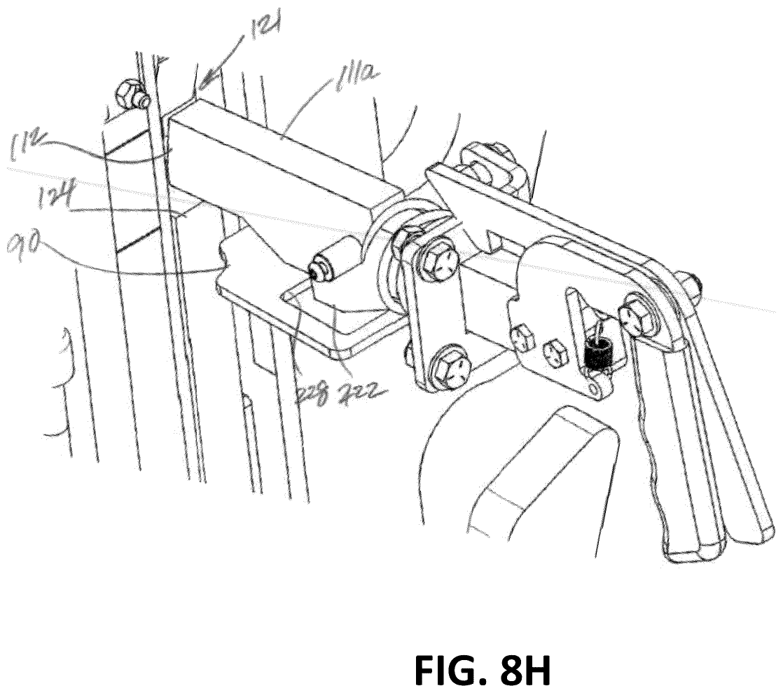

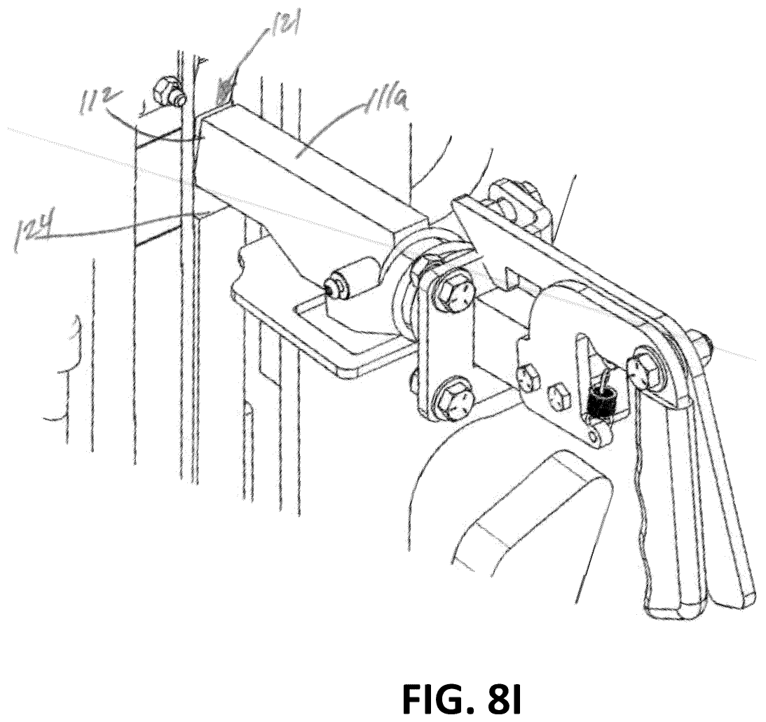

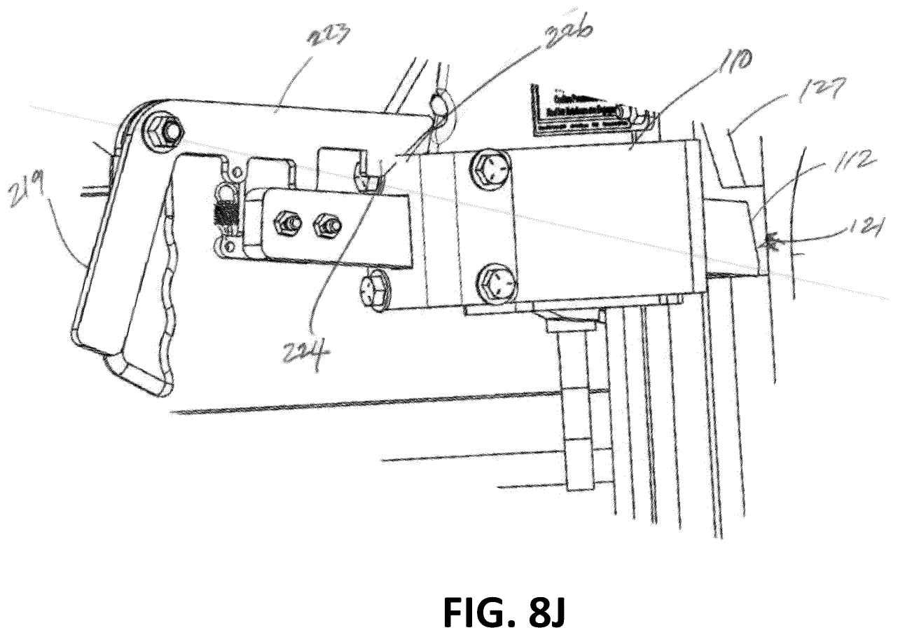

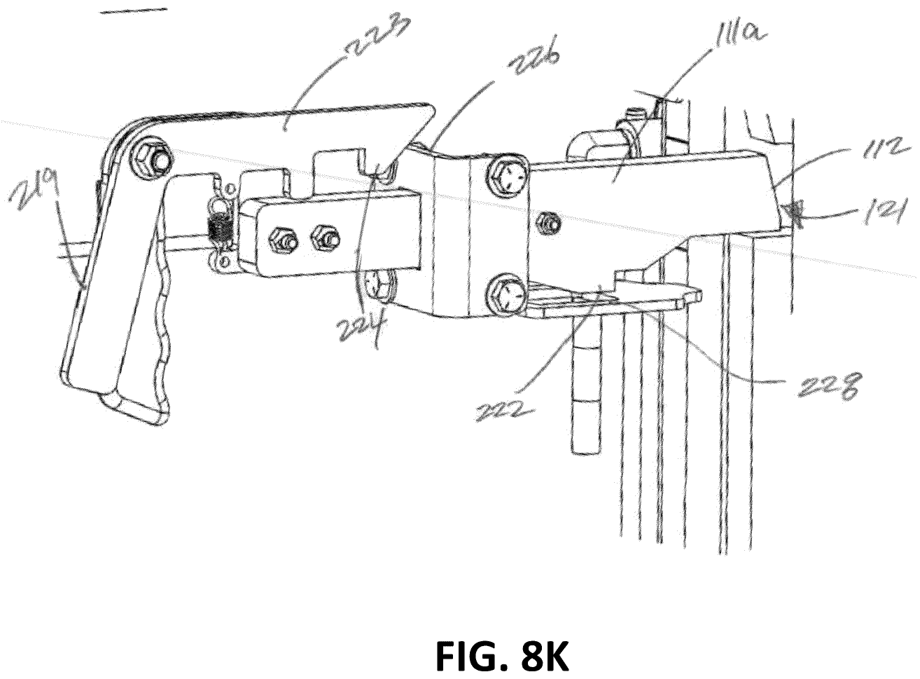

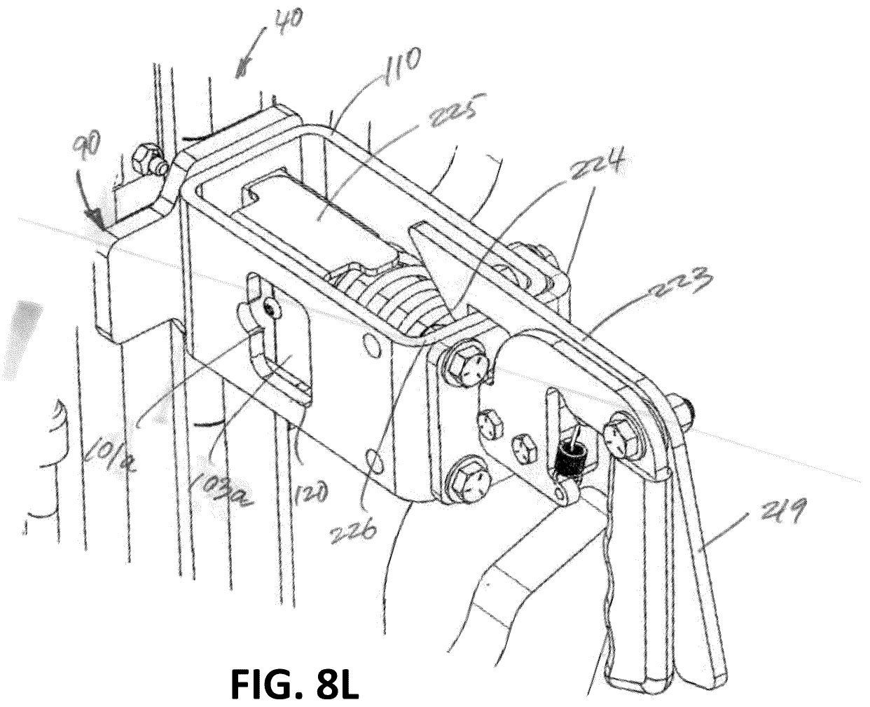

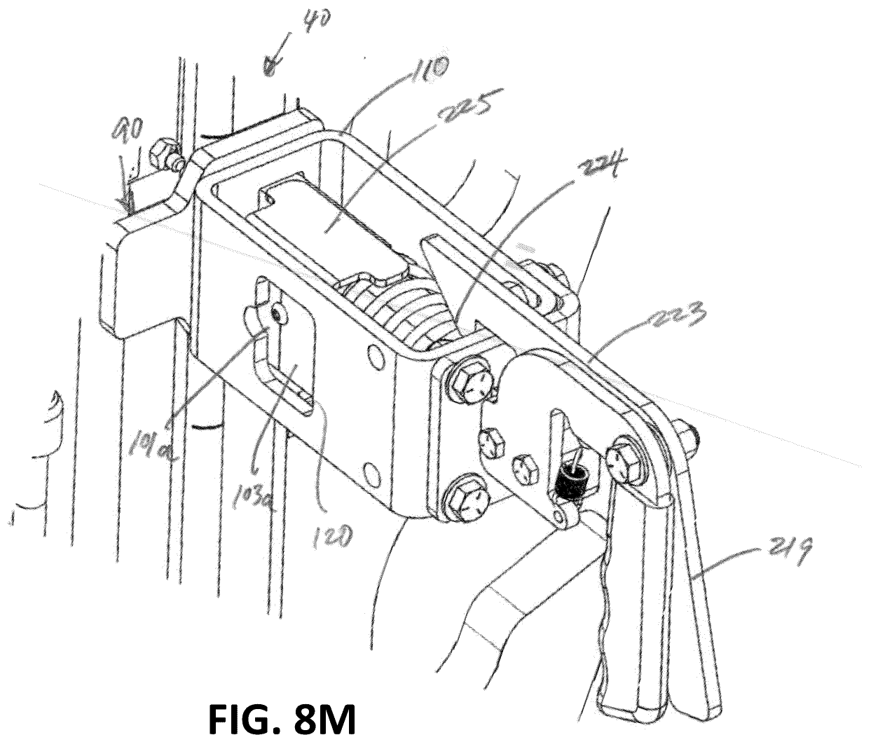

As shown in FIG. 6, the locking mechanism 200 is attached to the frame 36 for automatically locking the reel in place for stability and safety. The locking mechanism 200 has similar indicators as locking mechanism 100 to indicate whether the rack portion 40 is locked or unlocked. In this example, as shown in FIG. 8D, the locking mechanism 200 has a first indicator 101a indicating that the rack portion 40 is secured or locked and safe for travelling and a second indicator 103a indicating that the rack portion 40 is not secured or locked and unsafe for travelling,

Referring to FIG. 8A, the locking mechanism 200 includes a guard frame 110 to safeguard and surround a plunger shaft 111a that is configured to engage with rack member 56 of rack portion 40, which will be described in detail herein. More specifically, the plunger shaft 111a is configured to slide through the aperture 98 (FIG. 8C) and engage a portion of the rack portion 40 to lock the rack assembly 38 in place. At end 112 of plunger shaft 111a, a slanted edge is formed to engage with a portion of the rack portion 40 to enable the plunger shaft 111a to move. More specifically, end 112 is configured to engage a corresponding portion 127 (FIG. 8D) formed on the rack member 56, which moves the plunger shaft 111a in and out of the cut-out portion 121 of rack member 56. As further shown in FIG. 8A, the spring 115 surrounds the plunger shaft 111a which is configured to move in a compressed state and an uncompressed state, and produces the biasing force to move the plunger shaft 111a in and out of the rack member 56.

A handle 219 is attached at an end 118 of the plunger shaft 111a to release (or disengage) the plunger shaft 111a against the rack member 56 of the rack portion 40. By way of example, handle 219 includes two handle portions 220a, 220b that are configured to move towards and away from each other, dependent upon the operation. For instance, when the handle portions 220a, 220b are moved (i.e., squeezed) together, the handle 210 lifts a safety latch 224, formed at an end of a latch bar 223, to release the latch bar 223 from an edge portion 226 of the guard frame 110 (FIG. 8B). This initiates the disengagement operation and allows the plunger shaft 111a from moving away from the rack member 56. In some implementations, the safety latch 224 is formed in a hook-like shape to secure the safety latch 224 to the edge portion 226. As shown, the handle 219 further includes a spring 230 to provide a tensioning force to the latch bar 223 for urging the latch bar to move towards the guard frame 110.

Now to the operation of locking mechanism 200. FIGS. 8A-8M are sequential views showing the operation of the locking mechanism 200 between a locked/engaged state and an unlocked/disengaged state. Stated another way, these operational sequences show how the locking mechanism 200 transitions from the locked position in which the plunger shaft 111a is engaged with the rack member 56 of the rack portion 40 (FIG. 8A) to an unlocked position in which the plunger shaft 111a is disengaged with the rack member 56 of the rack portion 40 (FIG. 8B). Each of the rack portions 40 are simultaneously subjected to the same operations, and thus, only one side is shown and discussed.

Referring to FIG. 8B, the safety latch 224 of the handle 219 releases the plunger shaft 111a and disengages the plunger shaft 111a. This allows the plunger shaft 111a to be retracted or moved in a direction away from the rack member 56. Then, the handle 219 is further pulled (away from the rack member 56) until end 112 of plunger shaft 111a abuts against the edge portion 124 of the rack member 56 (FIG. 8D). While the rack member 56 is being lowered, the plunger shaft 111a begins to reverse direction and move back towards the rack member 56 until a notch 222 (formed on a lower side of the plunger shaft 111a) rests on (or abuts against) an edge portion 228 of the frame 90 (FIG. 8E). At this moment, the plunger shaft 111a has moved farther away from the rack member 56 displaying the second indicator 103, indicating an unlocked/disengaged position (FIG. 8C). As shown, indicator 103a is adjacent to indicator 101a (FIG. 8D), and when the locking mechanism 200 is disengaged, indicator 103a is shown through opening 120, due to the plunger shaft 111a being moved farther from the rack member 56 (FIG. 8C). Conversely, when the locking mechanism 200 is engaged or in the locked position, indicator 101a is shown through opening 120, due to the plunger shaft 111a being moved closer to the rack member 56 (FIG. 8B). As shown, an extension member 225 is attached to the first and second indicators 101a, 103a to reinforce and stabilize the structure thereof. In other words, the extension member 225 reduces any compressive forces applied to the indicators 101a, 103a.

As the rack member 56 continues to be lowered, the plunger shaft 111a then starts to catch and stop on a portion of the rack member 56, disengaging the rack member 56 (FIG. 8E). As shown, the slanted end 112 pushes the plunger shaft 111 out of the cut-out portion 121 as the rack member 56 is lowered and abuts against portion 128 of rack member 56, disengaging the plunger shaft 111 from the rack member 56 (FIG. 8G). This in turn moves the plunger shaft 111 in a direction away from the rack member 56 for displaying the second indicator 103a while hiding the first indicator 101a (FIG. 8F).

After the rack member 56 has been lowered to its desired position and the plunger shaft 111a has completely disengaged, the reel can be installed onto the roller 34. In order to now lock the plunger shaft 111a, the rack member 56 begins to rise so that the plunger shaft 111a will slide back into the cut-out portion 121 until the notch 222 engages the edge 228 of the frame 90 (FIG. 8H). While the rack member 56 continues to move upwards, the plunger shaft 111a begins to move (slide) into the cut-out portion 121 of the frame 90 (FIG. 8H). Because the rack member 56 continues to move upwards and pushes up on the bottom of the plunger shaft 111a, this releases the notch 222 of the plunger shaft 111a from the frame 90, which slides the plunger shaft 111a into eventually into the locked position (FIG. 8I). More specifically, as shown in FIGS. 8J-8L, when the rack member 56 is rising, this pushes up on the bottom side of the plunger shaft 111a (FIG. 8J), then the plunge shaft 111a begins to slightly raise so that the notch 222 is released from the edge portion 228 of frame 90 (FIG. 8K). As a result, this permits the plunger shaft 111a to slide back into the cut-out portion 121 to be in a locked state (FIG. 8L). This in turn provides the first indicator 101a to be visible through the opening 120 and second indicator 103a to be hidden from view. In the final stage, the spring loaded safety latch 224 slides over edge portion 228 of the guard frame 110, which automatically locks the plunger shaft 111a back for transporting.

As described herein, the term “proximal” end relates to an end being closest to the user, and the term “distal” end relates to an end being farthest from the user.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A pinless reel trailer, comprising:
a pair of frames, each frame for supporting a corresponding portion of a rack of a rack assembly movable along the respective frame, each rack portion having a protrusion extending outwardly from a surface of the rack portion for supporting a reel; and
a locking mechanism attached to each of the frames for locking in place the rack portion carrying the reel, the locking mechanism includes a plunger shaft that engages a portion of the rack portion to lock/unlock the plunger shaft against the rack portion, the plunger shaft being surrounded by a guard member that includes an opening,
wherein, in a first position, the plunger shaft is configured to be slidable to display a first indicator that is viewed through the opening of the guard member, indicating a locked state, and
wherein, in a second position, the plunger shaft is configured to be slidable to display a second indicator that is viewed outside of the guard member, indicating an unlocked state.

2. The pinless reel trailer according to claim 1, wherein the first indicator is viewed in a perpendicular direction with respect to a movement of the plunger shaft.

3. The pinless reel trailer according to claim 1, wherein the second indicator is viewed in a perpendicular direction with respect to a movement of the plunger shaft.

4. The pinless reel trailer according to claim 1, wherein the first and second indicators are at least one of a color, a marking, a graphic, an image, or a word.

5. The pinless reel trailer according to claim 1, wherein the plunger shaft includes a first end portion and a second end portion, the first end portion directly engages a portion of the rack portion to lock/unlock the plunger shaft, and the second end portion is attached to a handle.

6. The pinless reel trailer according to claim 5, wherein the first end portion of the plunger shaft slides in and out of a cut-out portion of the rack portion to lock/unlock the plunger shaft against the rack portion.

7. The pinless reel trailer according to claim 5, wherein the first end portion is slanted at an angled, wherein in response to the plunger shaft being disengaged, the first end portion abut against a portion of the rack portion.

8. The pinless reel trailer according to claim 5, wherein the plunger shaft includes a notch at a bottom edge portion thereof, wherein the notch is configured to operatively engage with an edge of a frame to prevent further movement towards the rack portion.

9. The pinless reel trailer according to claim 5, further comprising a spring member surrounding the plunger shaft, wherein the spring member is configured to move in a compressed state and an uncompressed state such that an appropriate force is applied to the plunger shaft to move towards and away from the rack member.

10. A pinless reel trailer, comprising:
a pair of frames, each frame for supporting a corresponding portion of a rack of a rack assembly movable along the respective frame, each rack portion having a protrusion extending outwardly from a surface of the rack portion for supporting a reel; and
a locking mechanism attached to each of the frames for locking in place the rack portion carrying the reel, the locking mechanism includes a plunger shaft, surrounded by a guard member, having a first end that engages a portion of the rack portion to lock the plunger shaft against the rack portion and a second end attached to a handle,
wherein in response to an application of force by the handle, the handle disengages with the guard member, permitting movement of the plunger shaft towards the rack portion.

11. The pinless reel trailer according to claim 10, wherein the guard member includes an opening to display a first indicator or a second indicator.

12. The pinless reel trailer according to claim 11, wherein, in a first position, the plunger shaft is configured to be slidable to display the first indicator through the opening, indicating a locked state.

13. The pinless reel trailer according to claim 11, wherein, in a second position, the plunger shaft is configured to be slidable to display the second indicator through the opening, indicating an unlocked state.

14. The pinless reel trailer according to claim 12, wherein the first indicator is a color green.

15. The pinless reel trailer according to claim 13, wherein the second indicator is a color red.

16. The pinless reel trailer according to claim 10, wherein the handle includes a latch bar having a latch at an end thereof, wherein, in response to the handle being operated, the latch disengages with an edge portion of the guard member so as to permit movement of the plunger shaft towards and away from the rack portion.

17. The pinless reel trailer according to claim 10, wherein the first end portion of the plunger shaft slides in and out of a cut-out portion of the rack portion to lock/unlock the plunger shaft against the rack portion.

18. The pinless reel trailer according to claim 10, wherein the first end portion is slanted at an angled, wherein in response to the plunger shaft being disengaged, the first end portion abut against a portion of the rack portion.

19. The pinless reel trailer according to claim 18, wherein, in response to the plunger shaft being engaged, the first end portion is completely inside of the cut-out portion to lock the plunger shaft against the rack portion.

20. The pinless reel trailer according to claim 10, wherein the plunger shaft includes a notch at a bottom edge portion thereof, wherein the notch is configured to operatively engage with an edge of a frame to prevent further movement towards the rack portion.
